(19) United States
(12) Patent Application Publication
(10) Pub. No.: US 2026/0119859 A1
(43) Pub. Date: Apr. 30, 2026

(54) PREDICTION BASED ON ASYNCHRONOUS AND HETEROGENEOUS TIME-SERIES DATA STREAMS

(71) Applicant: Infosys Limited, Bangalore (IN)

(72) Inventors: Syed Ahmed, Bengaluru (IN); Ramjee Rajasekaran, Bengaluru (IN)

(73) Assignee: Infosys Limited, Bangalore (IN)

(21) Appl. No.: 19/366,854

(22) Filed: Oct. 23, 2025

(30) Foreign Application Priority Data
Oct. 24, 2024 (IN) 202441081235

(51) Int. Cl. G06N 3/063; G06F 16/2455; G06F 18/25; G06F 123/02

(52) U.S. Cl. CPC G06N 3/063; G06F 16/24568; G06F 18/253; G06F 2123/02

(57) ABSTRACT

A method and system for prediction based on asynchronous and heterogeneous time-series data streams is provided. The asynchronous and heterogeneous time-series data streams are aligned onto a unified temporal grid. The aligned time-series data streams are synchronous, and sampling frequencies of the aligned time-series data streams are identical. Cross-attention is executed on the aligned time-series data streams across multiple attention windows. Each attention window is associated with a different time duration. A cross-attention output is generated based on the execution of the cross-attention for each attention window. Fused embeddings are generated based on the cross-attention outputs generated for the multiple attention windows. A prediction output is generated based on the plurality of fused embeddings for the time-series data streams.

### FIELD OF THE DISCLOSURE

Various embodiments of the present disclosure relate generally to machine learning models. More specifically, various embodiments of the present disclosure relate to a system and method for prediction based on asynchronous and heterogeneous time-series data streams.

### BACKGROUND

Machine learning techniques are increasingly employed in a wide variety of domains to perform tasks such as prediction, classification, anomaly detection, decision support, or the like. These techniques often rely on data streams collected from multiple sources to achieve accuracy and robustness. For example, in healthcare applications, physiological signals such as heart rate, blood pressure, and electroencephalogram (EEG) data may be combined with patient demographics and medical history to support diagnostic decision-making. In industrial settings, sensor data from equipment (e.g., temperature, vibration, and acoustic signals) may be fused with operational logs to predict equipment failures.

While the use of multiple data streams improves the performance of machine learning models, several technical challenges arise when these data streams are heterogeneous. The data sources may be of different modalities, including, for example, time-series sensor signals, images, textual data, categorical attributes, or the like. Further, these data streams may be asynchronous, meaning that data points from one stream do not necessarily align in time with those from another. Additionally, data streams may have different sampling frequencies. For example, accelerometer data may be collected at hundreds of Hertz, while temperature sensors may record once per minute. Such heterogeneity complicates the process of combining and processing data.

In light of the foregoing, there exists a need for a technical and reliable solution that overcomes the abovementioned problems.

Limitations and disadvantages of conventional and traditional approaches will become apparent to one of skill in the art, through the comparison of the described systems with some aspects of the present disclosure, as set forth in the remainder of the present disclosure and with reference to the drawings.

### SUMMARY

Methods and systems for prediction based on asynchronous and heterogeneous time-series data are provided substantially as shown in, and described in connection with, at least one of the figures.

In an embodiment, a system is disclosed. The system comprises processing circuitry configured to receive a plurality of time-series data streams associated with a plurality of heterogeneous data types, respectively. At least one time-series data stream of the plurality of time-series data streams is asynchronous with respect to at least one remaining time-series data stream of the plurality of time-series data streams. Further, a sampling frequency of at least one time-series data stream of the plurality of time-series data streams is different from a sampling frequency of at least one remaining time-series data stream of the plurality of time-series data streams. Further, the processing circuitry is configured to align the plurality of time-series data streams onto a unified temporal grid. The plurality of aligned time-series data streams is synchronous, and a sampling frequency of each aligned time-series data stream is same as a sampling frequency of each remaining aligned time-series data stream of the plurality of aligned time-series data streams. The processing circuitry is further configured to execute cross-attention on the plurality of aligned time-series data streams for each attention window of a plurality of attention windows. A time duration associated with each attention window of the plurality of attention windows is different from a time duration associated with each remaining attention window of the plurality of attention windows. The processing circuitry is further configured to generate a plurality of fused embeddings based on the execution of the cross-attention. Furthermore, the processing circuitry is configured to generate, based on the plurality of fused embeddings, a prediction output for the received plurality of time-series data streams.

In some embodiments, the system comprises a storage element coupled to the processing circuitry. The storage element is configured to store a machine learning (ML) model. Further, the processing circuitry is configured to execute the ML model based on the plurality of time-series data streams to align the plurality of time-series data streams onto the unified temporal grid. Furthermore, the ML model is configured to receive the plurality of time-series data streams as input, where each time-series data stream includes a plurality of input embedding values. The processing circuitry is further configured to determine a sampling frequency for the unified temporal grid based on the plurality of time-series data streams. Further, the unified temporal grid represents a plurality of sample points based on the determined sampling frequency. Further, the processing circuitry is configured to align, for each sample point of the plurality of sample points, corresponding one or more input embedding values of a corresponding plurality of input embedding values for the at least one time-series data stream of the plurality of time-series data streams. Furthermore, the processing circuitry is configured to output the plurality of aligned time-series data streams based on the alignment for each sample point of the plurality of sample points.

In some embodiments, the alignment for each sample point of the plurality of sample points for a corresponding time-series data stream of the plurality of time-series data streams is based on the corresponding time-series data stream.

In some embodiments, the alignment for each sample point of the plurality of sample points for a corresponding time-series data stream of the plurality of time-series data streams is based on the corresponding time-series data stream and one or more remaining time-series data streams of the plurality of time-series data streams.

In some embodiments, the ML model includes a set of interpolation kernel layers configured to align, for each sample point of the plurality of sample points, the corresponding one or more input embedding values of the corresponding plurality of input embedding values for the at least one time-series data stream of the plurality of time-series data streams.

In some embodiments, the ML model includes a set of dynamic time warping (DTW) neural layers configured to align, for each sample point of the plurality of sample points, the corresponding one or more input embedding values of the corresponding plurality of input embedding values for the at least one time-series data stream of the plurality of time-series data streams.

In some embodiments, the ML model includes a set of self-attention layers configured to align, for each sample point of the plurality of sample points, the corresponding one or more input embedding values of the corresponding plurality of input embedding values for the at least one time-series data stream of the plurality of time-series data streams.

In some embodiments, the ML model includes a set of cross-attention layers configured to align, for each sample point of the plurality of sample points, the corresponding one or more input embedding values of the corresponding plurality of input embedding values for the at least one time-series data stream of the plurality of time-series data streams.

In some embodiments, the system further comprises a storage element coupled to the processing circuitry. The storage element is configured to store a plurality of encoding models. Furthermore, the processing circuitry is configured to provide the plurality of time-series data streams as input to the plurality of encoding models, respectively. Further, the processing circuitry is configured to obtain a plurality of encoded time-series data streams as output of the plurality of encoding models, respectively. Further, the plurality of encoded time-series data streams is aligned onto the unified temporal grid. Furthermore, each encoding model of the plurality of encoding models is configured to receive a corresponding time-series data stream of the plurality of time-series data streams. The encoding model is configured to generate an encoded time-series data stream based on the received time-series data stream. The encoded time-series data stream is suitable for ML processing. Furthermore, the encoding model is configured to output the encoded time-series data stream.

In some embodiments, the processing circuitry is further configured to determine the plurality of attention windows based on the plurality of time-series data streams and the unified temporal grid.

In some embodiments, the system further comprises a storage element coupled to the processing circuitry. The storage element is further configured to store a machine learning (ML) model. The processing circuitry is configured to execute the cross-attention based on the ML model. The ML model includes a plurality of attention layers associated with the plurality of attention windows, respectively. Further, each attention layer of the plurality of attention layers is configured to receive the plurality of aligned time-series data streams. Furthermore, each attention layer of the plurality of attention layers is configured to perform the cross-attention on the plurality of aligned time-series data streams based on a corresponding attention window of the plurality of attention windows. Additionally, each attention layer of the plurality of attention layers is further configured to generate a cross-attention output based on the performed cross-attention.

In some embodiments, to perform the cross-attention on the plurality of aligned time-series data streams, each attention layer of the plurality of attention layers is configured to generate a plurality of queries, a plurality of keys, and a plurality of values for each aligned time-series data stream of the plurality of aligned time-series data streams. Further, each attention layer of the plurality of attention layers is configured to determine, for each aligned time-series data stream of the plurality of aligned time-series data streams, a plurality of attention scores between a corresponding plurality of queries and a plurality of keys associated with each remaining aligned time-series data stream of the plurality of aligned time-series data streams. Furthermore, each attention layer of the plurality of attention layers is further configured to generate, for each aligned time-series data stream of the plurality of aligned time-series data streams, a plurality of output values based on a corresponding plurality of attention scores and a plurality of values associated with each remaining aligned time-series data stream of the plurality of aligned time-series data streams. Further, the cross-attention output is generated based on the plurality of output values associated with each aligned time-series data stream of the plurality of aligned time-series data streams.

In some embodiments, each attention layer of the plurality of attention layers is configured to perform the cross-attention in parallel.

In some embodiments, the processing circuitry is configured to generate the plurality of fused embeddings further based on the ML model. The ML model further includes a fusion layer. Further, the fusion layer is configured to receive the cross-attention output generated by each attention layer of the plurality of attention layers. Furthermore, hierarchically fuse the received cross-attention outputs to generate the plurality of fused embeddings.

In some embodiments, the plurality of attention windows includes a first attention window, a second attention window, and a third attention window. Further, a time duration associated with the first attention window is shorter than a time duration associated with the second attention window, and the time duration associated with the second attention window is shorter than a time duration associated with the third attention window.

In some embodiments, the system further comprises a storage element coupled to the processing circuitry and configured to store a machine learning (ML) model. The processing circuitry is configured to generate the prediction output further based on the ML model. The ML model further includes a set of prediction layers. Furthermore, the set of prediction layers is configured to receive the plurality of fused embeddings. Further, the set of prediction layers is configured to generate the prediction output based on the received plurality of fused embeddings.

In another embodiment of the present disclosure, a method is disclosed. The method comprises receiving a plurality of time-series data streams associated with a plurality of heterogeneous data types, respectively. At least one time-series data stream of the plurality of time-series data streams is asynchronous with respect to at least one remaining time-series data stream of the plurality of time-series data streams. Further, a sampling frequency of at least one time-series data stream is different from a sampling frequency of at least one remaining time-series data stream of the plurality of time-series data streams. Further, the method comprises aligning the plurality of time-series data streams onto a unified temporal grid. The plurality of aligned time-series data streams is synchronous, and a sampling frequency of each aligned time-series data stream is same as a sampling frequency of each remaining aligned time-series data stream of the plurality of aligned time-series data streams. Further, the method comprises executing cross-attention on the plurality of aligned time-series data streams for each attention window of a plurality of attention windows. A time duration associated with each attention window of the plurality of attention windows is different from a time duration associated with each remaining attention window of the plurality of attention windows. The method further comprises generating a plurality of fused embeddings based on the execution of the cross-attention. Further, the method comprises generating, based on the plurality of fused embeddings, a prediction output for the plurality of time-series data streams.

In some embodiments, the method comprises determining a sampling frequency for the unified temporal grid based on the plurality of time-series data streams. The unified temporal grid represents a plurality of sample points based on the determined sampling frequency. Further, each time-series data stream includes a plurality of input embedding values. Further, the method comprises aligning, for each sample point of the plurality of sample points, corresponding one or more input embedding values of a corresponding plurality of input embedding values for the at least one time-series data stream of the plurality of time-series data streams.

In some embodiments, the alignment for each sample point of the plurality of sample points for a corresponding time-series data stream of the plurality of time-series data streams is based on the corresponding time-series data stream and one or more remaining time-series data streams of the plurality of time-series data streams.

In yet another embodiment of the present disclosure, a computer-readable medium is disclosed. The computer-readable medium comprises instructions that, when executed by processing circuitry of a computing system, cause the computing system to perform a method. The method comprises receiving a plurality of time-series data streams associated with a plurality of heterogeneous data types, respectively. At least one time-series data stream of the plurality of time-series data streams is asynchronous with respect to at least one remaining time-series data stream of the plurality of time-series data streams. Further, a sampling frequency of at least one time-series data stream is different from a sampling frequency of at least one remaining time-series data stream of the plurality of time-series data streams. Further, the method comprises aligning the plurality of time-series data streams onto a unified temporal grid. The plurality of aligned time-series data streams is synchronous, and a sampling frequency of each aligned time-series data stream is same as a sampling frequency of each remaining aligned time-series data stream of the plurality of aligned time-series data streams. Further, the method comprises executing cross-attention on the plurality of aligned time-series data streams for each attention window of a plurality of attention windows. A time duration associated with each attention window of the plurality of attention windows is different from a time duration associated with each remaining attention window of the plurality of attention windows. The method further comprises generating a plurality of fused embeddings based on the execution of the cross-attention. Further, the method comprises generating, based on the plurality of fused embeddings, a prediction output for the plurality of time-series data streams.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

Embodiments of the present disclosure are illustrated by way of example and are not limited by the accompanying figures. Similar references in the figures may indicate similar elements. Elements in the figures are illustrated for simplicity and clarity and have not necessarily been drawn to scale.

FIG. 1 is a block diagram that illustrates an environment for prediction based on asynchronous and heterogeneous time-series data streams, consistent with disclosed embodiments of the present disclosure;

FIG. 2 is a schematic diagram that illustrates a machine learning (ML) model of the environment of FIG. 1, consistent with disclosed embodiments of the present disclosure;

FIG. 3 represents a flowchart that illustrates a method for prediction based on asynchronous and heterogeneous time-series data streams, consistent with disclosed embodiments of the present disclosure; and

FIG. 4 shows an example computing system for carrying out the methods of the present disclosure, consistent with disclosed embodiments of the present disclosure.

### DETAILED DESCRIPTION

The detailed description of the appended drawings is intended as a description of the embodiments of the present disclosure and is not intended to represent the only form in which the present disclosure may be practiced. It is to be understood that the same or equivalent functions may be accomplished by different embodiments that are intended to be encompassed within the spirit and scope of the present disclosure.

### Overview:

Conventional solutions for processing asynchronous and heterogeneous data streams typically rely on fusion-based methods such as early fusion, late fusion, or intermediate fusion. These methods combine information from multiple modalities or sources to generate predictions or classifications. In early fusion, raw data streams or low-level features from different modalities are combined at an input stage, and a single machine learning (ML) model is trained on the joint representation. While this approach enables joint modelling of the modalities, it relies on an assumption of temporal and structural synchronization across data streams. When the data streams are asynchronous or sampled at different rates, early fusion often employs forced alignment or interpolation, which may introduce artifacts, degrade signal integrity, and result in inaccurate modelling of the underlying temporal dynamics.

In late fusion, separate models are trained on individual data streams, and their outputs, such as predicted labels, probabilities, or embeddings, are combined at a higher decision level. However, late fusion discards fine-grained temporal correlations and interactions across modalities, leading to loss of information that may be crucial for accurate prediction or classification in time-sensitive applications.

Intermediate fusion methods attempt to address these issues by combining modalities at intermediate feature levels. Techniques such as attention mechanisms or transformer-based architectures have been introduced to capture cross-modal dependencies. While these approaches offer improved flexibility, they assume fixed or predefined temporal alignment among modalities. As a result, they cannot dynamically adapt to temporal variations across heterogeneous data streams. This limitation reduces their effectiveness in scenarios where data sources are asynchronous and subject to varying sampling frequencies.

The present disclosure addresses these limitations by providing a system and method for prediction based on asynchronous and heterogeneous time-series data streams. The system may include processing circuitry that may receive time-series data streams associated with heterogeneous data types. The time-series data streams are asynchronous and a sampling frequency of each time-series data stream may be different. The processing circuitry may align the time-series data streams onto a unified temporal grid such that the aligned time-series data streams are synchronous and each aligned time-series data stream has a same sampling frequency. The processing circuitry may execute an ML model based on the time-series data streams to align the time-series data streams onto the unified temporal grid. Further, the processing circuitry may execute cross-attention on the aligned time-series data streams for each attention window of multiple attention windows. A time duration associated with each attention window in the multiple attention windows is different from time duration associated with each remaining attention window. Additionally, fused embeddings may be generated based on the execution of the cross-attention. Cross-attention output obtained for each attention window may be used to generate the fused embeddings. The processing circuitry may generate, based on the fused embeddings, a prediction output for the received time-series data streams.

In the present disclosure, unlike existing multi-modal fusion techniques that assume synchronized or uniformly sampled data, the ML model that actively learns is used to dynamically align the heterogeneous time-series data streams onto the unified temporal grid, irrespective of original sampling frequencies. Additionally, conventional fusion methods employ single-scale attention or simple feature concatenation, thereby resulting in missing temporal dependencies at multiple resolutions. In contrast, the system disclosed in the present disclosure employs execution of cross-attention in multiple attention windows of different time durations, for example, short-term, mid-term, and long-term attention windows, thus capturing rich cross-modal interactions at varying granularities of time. Thus, the present disclosure enables robust fusion and contextual understanding of temporally misaligned multi-modal data, overcoming the synchronization and temporal resolution limitations inherent in the conventional multi-modal machine learning systems. It is appreciated that the human mind is not equipped to align the asynchronous time-series data streams and execute the cross-attention on the aligned time-series data streams, given the digital interconnectedness of the alignment of the asynchronous time-series data streams and the execution of the cross-attention on the aligned time-series data streams.

### FIGURE DESCRIPTION

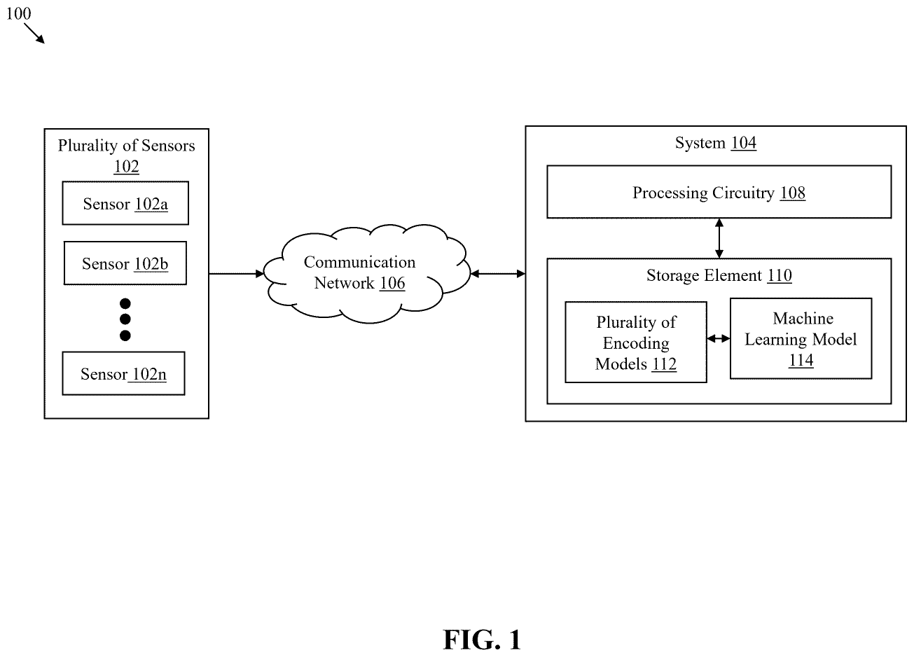

FIG. 1 is a block diagram that illustrates an environment 100 for prediction based on asynchronous and heterogeneous time-series data streams, consistent with disclosed embodiments of the present disclosure.

The environment 100 is shown to include a plurality of sensors 102 and a system 104. The plurality of sensors 102 may be communicatively coupled to the system 104 by way of a communication network 106. The plurality of sensors 102 may include sensors 102a-102n.

Each sensor of the plurality of sensors 102 may include suitable logic, circuitry, interfaces, and/or code, executable by the circuitry, that may be configured to perform various sensing operations. For example, the sensor 102a may be configured to detect one or more parameters and convert the detected parameter(s) into an electrical signal. The parameters may be one or more of physical, chemical, environmental, biological, optical, acoustic, electrical, magnetic, radiological, mechanical, thermal, and so on. Further, the sensor 102a may be configured to process the electrical signal to generate digital or analog measurement data. Additionally, the sensor 102a may be configured to filter, condition, or refine the measurement data to reduce noise or interference therefrom. Furthermore, the sensor 102a may be configured to timestamp the measurement data with temporal information. Thus, the sensor 102a may generate a time-series data stream that includes a plurality of input embedding values that corresponds to measurement data. Further, the sensor 102a may transmit the generated time-series data stream to the system 104 by way of the communication network 106. Each remaining sensor of the plurality of sensors 102 may generate a corresponding time-series data stream, similarly to the generation of the time-series data stream by the sensor 102a. Thus, the plurality of sensors 102 may generate a plurality of time-series data streams, respectively.

In some examples, the plurality of sensors 102 may include the sensor 102a, the sensor 102b, the sensor 102c, and the sensor 102d. The sensor 102a may correspond to an audio sensor that may be operating at a frequency of 16 kilohertz (kHz), and the sensor 102b may correspond to an image sensor that may be configured to capture 25 frames per second. Further, the sensor 102c may correspond to an Electrocardiogram (ECG) that is configured to detect heart rate at a frequency of 1 Hz, and the sensor 102d may correspond to a smart sensor that may be configured to detect speech and convert the detected speech to text. The sensor 102a may generate a time-series data stream that includes audio data with a sampling frequency of 16 kHz, and the sensor 102b may generate a time-series data stream that includes video data with a sampling frequency of 25 frames per second. Further, the sensor 102c may generate a time-series data stream that includes heart rate data with a sampling frequency of 1 Hz. Additionally, the sensor 102d may generate a time-series data stream that includes text data with an irregular sampling frequency.

The plurality of time-series data streams generated by the plurality of sensors 102 is associated with a plurality of heterogeneous data types, respectively. The plurality of heterogeneous data types refers to data that originates from different sources and differs in format, structure, or measurement characteristics. Additionally, the plurality of data streams is asynchronous. In other words, input embedding values from one time-series data stream are not aligned in time with input embedding values from the remaining one or more time-series data streams. Further, the sampling frequency of each time-series data stream of the plurality of time-series data streams is different from the sampling frequency of each remaining time-series data stream of the plurality of time-series data streams. Further, each input embedding value of the plurality of input embedding values (e.g., the audio data, the video data, the heart rate data, or the text data) may be associated with a specific time instance or timestamp. Furthermore, each time-series data stream of the plurality of time-series data streams may span across a time duration. In a non-limiting example, each time-series data stream of the plurality of time-series data streams corresponds to a time duration of 3 seconds. The plurality of time-series data streams may be associated with monitoring a patient in a medical center.

Herein it will be understood, that the plurality of sensors 102 are described to include four sensors for the purpose of explanation and brevity of description, and the scope of the present disclosure is not limited to this example. In various embodiments, the plurality of sensors 102 may include less than or more than four sensors, without deviating from the scope of the present disclosure.

Although it is described that the plurality of sensors 102 includes the audio sensor, the image sensor, the ECG, and the smart sensor, the scope of the present disclosure is not limited to it. In various embodiments, the plurality of sensors 102 may include at least two of a temperature sensor, a pressure sensor, electrophysiological sensors such as an Electroencephalogram (EEG) sensor, or an Electromyography (EMG) sensor, environmental measurement sensors such as a temperature sensor or a humidity sensor, an accelerometer, a gyroscope, Light Detection and Ranging (LiDAR), a biometric sensor, or the like.

The system 104 may include suitable logic, circuitry, interfaces, and/or code, executable by the circuitry, that may be configured to generate predictions based on the plurality of time-series data streams that is asynchronous and heterogeneous. The system 104 may include processing circuitry 108 and a storage element 110 coupled to the processing circuitry 108. The storage element 110 may be configured to store a plurality of encoding models 112 and a machine learning (ML) model 114. The storage element 110 may correspond to hardware storage (for example, hard drive, solid-state drive, or the like) or cloud storage (for example, cloud services).

The processing circuitry 108 may include suitable logic, circuitry, interfaces, and/or code, executable by the circuitry, that may be configured to enable the generation of the predictions based on the plurality of time-series data streams. The processing circuitry 108 may be configured to perform one or more operations to enable the generation of the predictions based on the plurality of time-series data streams. For example, the processing circuitry 108 may be configured to receive the plurality of time-series data streams from the plurality of sensors 102. Each time-series data stream of the plurality of time-series data streams may correspond to raw measurement data detected by the corresponding sensor. To enable the generation of predictions based on the plurality of time-series data streams, the processing circuitry 108 may be configured to provide the plurality of time-series data streams as input to the plurality of encoding models 112, respectively.

The processing circuitry 108 may be further configured to obtain a plurality of encoded time-series data streams as output of the plurality of encoding models 112, respectively. The plurality of encoded time-series data streams may be suitable for ML processing. Thus, each encoded time-series data stream of the plurality of encoded time-series data streams may include a corresponding plurality of encoded input embedding values. An encoded input embedding value of the plurality of encoded input embedding values may represent a corresponding input embedding value in a format compatible with ML processing and may include numeric, vectorized, or embedded representations preserving information relevant to the generation of predictions. Generation of the plurality of encoded time-series data streams and the plurality of encoding models 112 are explained in the ongoing description.

The processing circuitry 108 may be further configured to align the plurality of encoded time-series data streams onto a unified temporal grid. The unified temporal grid may be associated with a unified time duration and a sampling frequency. The alignment of the plurality of encoded time-series data streams onto a unified temporal grid may result in a plurality of aligned time-series data streams that may be synchronous. Additionally, a sampling frequency of each aligned time-series data stream may be same as a sampling frequency of each remaining aligned time-series data stream of the plurality of aligned time-series data streams. Particularly, the sampling frequency of each of the plurality of aligned time-series data streams may be same as the sampling frequency associated with the unified temporal grid.

The processing circuitry 108 may be configured to execute the ML model 114 based on the plurality of encoded time-series data streams to align the plurality of encoded time-series data streams onto the unified temporal grid. The execution of the ML model 114 is described in the ongoing disclosure. The processing circuitry 108 may be further configured to determine a plurality of attention windows based on the plurality of time-series data streams and the unified temporal grid. Thus, a time duration associated with each attention window of the plurality of attention windows may be determined adaptively based on the received plurality of time-series data streams and the time duration associated with the unified temporal grid. The time duration associated with each attention window of the plurality of attention windows may be different from a time duration associated with each remaining attention window of the plurality of attention windows. In various examples, the processing circuitry 108 may split the time duration associated with the unified temporal grid into an overlapping or nested plurality of attention windows based on the plurality of time-series data streams. In some examples, the plurality of attention windows may include a first attention window, a second attention window, and a third attention window. Further, a time duration associated with the first attention window is shorter than a time duration associated with the second attention window, and the time duration associated with the second attention window is shorter than a time duration associated with the third attention window.

The processing circuitry 108 may be further configured to execute cross-attention on the plurality of aligned time-series data streams for each attention window of the plurality of attention windows. Through cross-attention, temporal features from different data streams are correlated, weighted, and combined based on their contextual relevance, thereby generating a joint representation that captures inter-stream dependencies and relationships. Cross-attention output may be generated, for each attention window of the plurality of attention windows, based on the execution of the cross-attention. Execution of the cross-attention for a single attention window may result in overlooking patterns that span longer or shorter periods than the single attention window. The execution of the cross-attention on the plurality of aligned time-series data streams for each attention window of the plurality of attention windows enables capturing of rich interactions between the plurality of aligned time-series data streams at varying granularities of time. For example, the execution of the cross-attention for the first attention window may capture fine-grained immediate interactions between the plurality of aligned time-series data streams. Further, the execution of the cross-attention for the second attention window may capture medium-duration dependencies between the plurality of aligned time-series data streams. Additionally, the execution of the cross-attention for the third attention window may capture longer-term temporal patterns between the plurality of aligned time-series data streams.

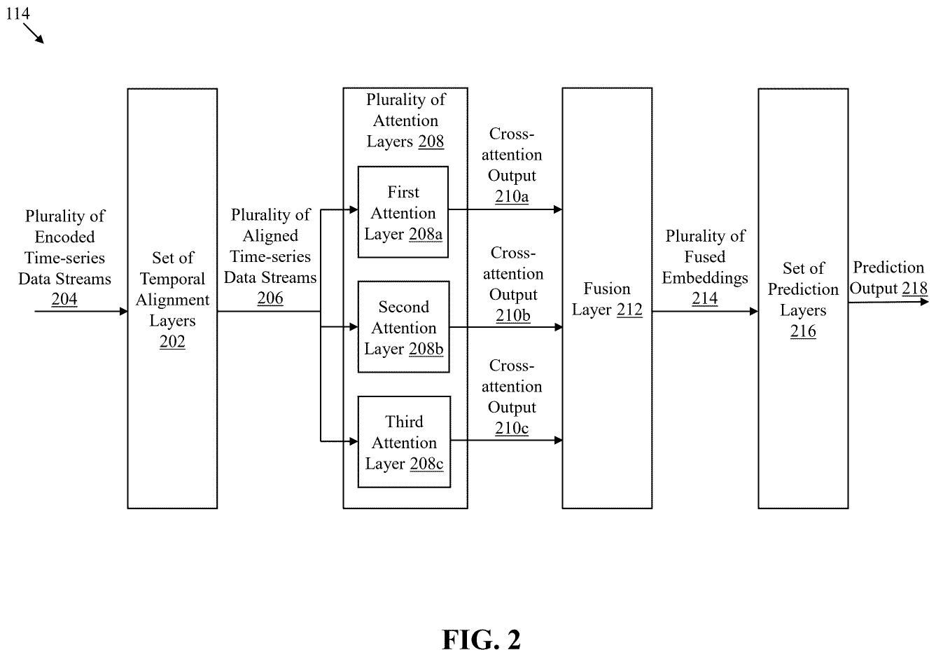

The processing circuitry 108 may be further configured to generate a plurality of fused embeddings based on the execution of the cross-attention. Particularly, the processing circuitry 108 may be configured to generate the plurality of fused embeddings based on the cross-attention output generated for each attention window of the plurality of attention windows. In various examples, the plurality of fused embeddings may correspond to a hierarchical fusion of the cross-attention outputs generated for the plurality of attention windows. The generation of the plurality of fused embeddings is described in detail in conjunction with FIG. 2.

The processing circuitry 108 may be further configured to generate, based on the plurality of fused embeddings, a prediction output for the received plurality of time-series data streams. The prediction output may correspond to one of a classification score, a regression value, an anomaly detection score, or a control command. The generation of the prediction output is described in detail in conjunction with FIG. 2.

An encoding model of the plurality of encoding models 112 may be configured to receive a corresponding time-series data stream of the plurality of time-series data streams. As described above, the time-series data stream may correspond to raw measurement data. Further, the encoding model may be configured to generate a corresponding encoded time-series data stream based on the received time-series data stream. The encoded time-series data stream may include a plurality of encoded input embedding values.

In some examples, the encoding model may generate the corresponding encoded time-series data stream further based on one or more positional embeddings. In a non-limiting example, a corresponding encoded input embedding value of the plurality of encoded input embedding values may be generated by the encoding model using equation (1):

$${E}_{m} ( t ) = {EncoderModel}_{m} ( {x}_{m} ( t ) ) + PositionalEmbedding ( t ) \qquad ( 1 )$$

where,
Eₘ(t) may represent an encoded input embedding value of a corresponding time-series data stream at time t,
xₘ(t) may represent an input embedding value of the corresponding time-series data stream at time t,
EncoderModelₘ may represent a corresponding encoding model of the plurality of encoding models 112, and
PositionalEmbedding(t) may represent positional embedding, such as sinusoidal embedding or learned positional vectors, representing temporal information.

Each remaining encoded input embedding value of the plurality of encoded input embedding values may be generated by the encoding model using equation (1). Further, the encoding model may be configured to output the generated encoded time-series data stream. Each encoding model of the plurality of encoding models 112 may be configured to generate and output the corresponding encoded time-series data stream in the above-described manner.

Each encoding model of the plurality of encoding models 112 may correspond to a transformer model, a Convolutional Neural Network (CNN), a Temporal Convolutional Network (TCN), a Structured State Space (S4), Long Short-Term Memory (LSTM), Gated Recurrent Unit (GRU), or the like. In some embodiments, the plurality of encoding models 112 may simultaneously generate the plurality of encoded time-series data streams, respectively. In reference to the above-described example, the plurality of encoding models 112 may include an audio encoding model, a video encoding model, a sensor encoding model, and a text encoding model.

The audio encoding model may receive the time-series data stream that includes the audio data and convert the audio data into frame-level embeddings to generate the corresponding encoded time-series data stream. Additionally, the audio encoding model may capture frequency, rhythm, and short-term temporal patterns from the audio data (e.g., waveform or spectrogram) for generating the corresponding encoded time-series data stream. In some examples, the audio encoding model may correspond to a one-dimensional (1D) CNN or an audio transformer. Continuing the above-described example, the 3-second duration of the audio data may be encoded into the corresponding encoded time-series data stream that represents 300 encoded input embedding values with an interval of 10 milliseconds (ms) between every two input embedding values. In a non-limiting example, the corresponding encoded time-series data stream may correspond to a 256-dimensional vector representing the 300 encoded input embedding values.

Further, the video encoding model may receive the time-series data stream that includes the video data and extract spatial context (objects, movement) and spatial-temporal features (e.g., short/mid-term temporal changes) from the video data to generate the corresponding encoded time-series data stream. In some examples, the video encoding model may correspond to a 3D CNN or a vision transformer. Continuing the above-described example, the video data may include 75 frames based on the time duration being 3 seconds and the sampling frequency being 25 fps. Thus, the plurality of encoded input embedding values may correspond to 75 encoded frames. Further, the corresponding encoded time-series data stream may correspond to a 256-dimensional vector representing the 75 encoded frames.

The sensor encoding model may receive the time-series data stream that includes the heart rate data and capture trends, seasonality, or abrupt changes in the heart rate data to generate the corresponding encoded time-series data stream. In some examples, the sensor encoding model may correspond to a TCN, an S4, an LSTM, or a GRU. Continuing the above-described example, the 3-second duration of the heart rate data may include 4 input embedding values based on the 1 Hz sampling frequency. Thus, the plurality of encoded input embedding values may correspond to 4 encoded input embedding values. Further, the corresponding encoded time-series data stream may correspond to a 128-dimensional vector representing the 4 encoded input embedding values.

The text encoding model may receive the time-series data stream that includes the text data and convert the discrete and irregular text data into continuous embeddings with proper timestamping to generate the corresponding encoded time-series data stream. In some examples, the text encoding model may correspond to a text transformer. Continuing the above-described example, in the 3-second duration of the text data, an input embedding value may be represented at 1.5 seconds and another input embedding value at 2.4 seconds. Thus, the plurality of encoded input embedding values may correspond to 2 encoded input embedding values. Further, the corresponding encoded time-series data stream may correspond to a 128-dimensional vector representing the 2 encoded input embedding values.

In some embodiments, each encoding model of the plurality of encoding models 112 may be further configured to identify timepoints of interest (e.g., sudden changes, peaks, gestures, keyword detections, or the like) in the corresponding time-series data stream. The identified timepoints may correspond to event markers that represent encoded input embedding values and associated timestamps for the identified timepoints of interest. Further, each encoding model of the plurality of encoding models 112 may be configured to output the corresponding event markers. In such embodiments, the processing circuitry 108 may adaptively determine the plurality of attention windows further based on the event markers associated with each time-series data stream of the plurality of time-series data streams. Thus, the time duration associated with each attention window of the plurality of attention windows may be dynamically learned based on the event markers associated with received plurality of time-series data streams instead of the time durations of the plurality of attention windows being fixed irrespective of the behavior of input data (e.g., the received plurality of time-series data streams). In various embodiments, the plurality of encoding models 112 may be trainable. In some examples, the processing circuitry 108 may be configured to train the plurality of encoding models 112.

The ML model 114 may be configured to enable the generation of predictions based on asynchronous and heterogeneous time-series data streams. The ML model 114 may be coupled to the plurality of encoding models 112. Based on the execution of the ML model 114, the ML model 114 may be configured to receive the plurality of encoded time-series data streams as input, where each encoded time-series data stream includes the corresponding plurality of encoded input embedding values. Further, the ML model 114 may be configured to determine the sampling frequency for the unified temporal grid based on the plurality of time-series data streams. The unified temporal grid may represent the plurality of sample points based on the determined sampling frequency. In some examples, the ML model 114 may determine the sampling frequency of one of the plurality of encoded time-series data streams as the sampling frequency of the unified temporal grid. In various examples, the sampling frequency that is higher among sampling frequencies associated with the plurality of encoded time-series data streams may be determined as the sampling frequency of the unified temporal grid. In additional examples, the sampling frequency of the unified temporal grid may be different from the sampling frequency associated with each encoded time-series data stream of the plurality of encoded time-series data streams.

Prior to the determination of the sampling frequency of the unified temporal grid, the ML model 114 may be further configured to determine the time duration associated with the unified temporal grid based on the time duration associated with each time-series data stream of the plurality of time-series data streams. Continuing the above-described example, the time duration of the unified temporal grid may be determined as 3 seconds. The plurality of sample points may span across the time duration of the unified temporal grid based on the sampling frequency of the unified temporal grid.

In some embodiments, the ML model 114 may be configured to determine the sampling frequency further based on the event markers associated with each of the plurality of encoded time-series data streams. As described above, the event markers may represent the encoded input embedding values and associated timestamps for the identified timepoints of interest (e.g., sudden changes, peaks, gestures, keyword detections, or the like) in the corresponding time-series data stream. In some examples, the sampling frequency of the unified temporal grid may be irregular. In other words, time intervals between consecutive samples may not be constant. In further examples, a position of each sampling point in the unified temporal grid may be parameterized as learnable variables to cover the most informative or data-rich time intervals. In additional examples, the ML model 114 may use higher resolution (denser sampling points) in regions with more rapid or complex events, and lower resolution (sparser sampling points) in periods of low activity in the unified temporal grid. In numerous examples, one or more sampling points of the plurality of sampling points may be directly tied to the timestamps of identified events represented by the event markers. Thus, the sampling frequency of the unified temporal grid is adaptively determined instead of being fixed.

The ML model 114 may be further configured to align, for each sample point of the plurality of sample points, corresponding one or more encoded input embedding values of a corresponding plurality of encoded input embedding values for each time-series data stream of the plurality of time-series data streams. In some examples, for a sample point of the plurality of sample points, an encoded input embedding value of the corresponding plurality of encoded input embedding values may be aligned. In some additional examples, for a sample point of the plurality of sample points, a combination of the one or more encoded input embedding values of the corresponding plurality of encoded input embedding values may be aligned. The combination may correspond to one of concatenation, aggregation, fusion, or the like.

The ML model 114 may be further configured to output the plurality of aligned time-series data streams based on the alignment for each sample point of the plurality of sample points. The plurality of aligned time-series data streams is synchronous based on the alignment onto the unified temporal grid. Additionally, the sampling frequency of each of the plurality of aligned time-series data streams is same as the sampling frequency of the unified temporal grid. The ML model 114 may be further configured to enable the generation of the prediction output based on the plurality of aligned time-series data streams. The ML model 114 is further described in detail in conjunction with FIG. 2.

The communication network 106 may facilitate communication between the plurality of sensors 102 and the system 104. Examples of the communication network 106 may include but are not limited to, a Wi-Fi network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. Various entities in the environment 100 may connect to the communication network 106 in accordance with various wired and wireless communication protocols, such as Transmission Control Protocol and Internet Protocol (TCP/IP), User Datagram Protocol (UDP), Long Term Evolution (LTE) communication protocols, or any combination thereof.

FIG. 2 is a schematic diagram that illustrates the ML model 114, consistent with disclosed embodiments of the present disclosure.

The ML model 114 may include a set of temporal alignment layers 202. The set of temporal alignment layers 202 may be configured to receive the plurality of encoded time-series data streams (hereinafter referred to as “the plurality of encoded time-series data streams 204”). Further, the set of temporal alignment layers 202 may determine the time duration and the sampling frequency associated with the unified temporal grid based on the plurality of encoded time-series data streams 204. The time duration and the sampling frequency associated with the unified temporal grid are dynamically determined based on the received plurality of encoded time-series data streams 204. The unified temporal grid may represent the plurality of sampling points based on the sampling frequency. Continuing the example described in FIG. 1, the plurality of sampling points may include 300 sample points that span across 3 seconds with a 10 ms interval between every two sample points of the plurality of sample points.

Further, the set of temporal alignment layers 202 may be configured to align, for each sample point of the plurality of sample points, the corresponding one or more encoded input embedding values of the corresponding plurality of encoded input embedding values for each encoded time-series data stream of the plurality of encoded time-series data streams 204. Additionally, the set of temporal alignment layers 202 may be configured to output the plurality of aligned time-series data streams (hereinafter referred to as “the plurality of aligned time-series data streams 206”).

Continuing the above-described example, in a non-liming example, based on the alignment, 240th sample point of the plurality of sampling points may represent the 240th encoded input embedding value associated with the audio data, 60th encoded input embedding value that represents 60th frame of the video data, a combination of the encoded input embedding values at 2 second and 3 second associated with the heart rate data, and the encoded input embedding value at 2.4 second of the text data.

In some embodiments, the alignment for each sample point of the plurality of sample points for a corresponding encoded time-series data stream of the plurality of encoded time-series data streams 204 may be based on the corresponding encoded time-series data stream. In other words, the alignment for each sample point of the plurality of sample points for the corresponding time-series data stream of the plurality of time-series data streams may be independent of the remaining time-series data streams of the plurality of time-series data streams. For example, the alignment of the video data into the unified temporal grid may be based on the encoded time-series data stream for the video data.

In some embodiments, the alignment for each sample point of the plurality of sample points for a corresponding encoded time-series data stream of the plurality of encoded time-series data streams 204 may be based on the corresponding encoded time-series data stream and one or more remaining encoded time-series data streams of the plurality of encoded time-series data streams 204. For example, the alignment of the video data into the unified temporal grid may be based on the encoded time-series data stream for the video data and the encoded time-series data stream for the audio data. Thus, the alignment for one time-series data stream may be influenced by features or events in another time-series data stream, thereby enabling cross-modal temporal guidance during the alignment. In some examples, the set of temporal alignment layers 202 may perform the above-described alignment based on equation (2):

$${L}_{align} = {\sum }_{m , n ∈ modalities} {\sum }_{t} \vert \vert {f}_{align}^{m , n} ( {E}_{m} ( t ) ) - {E}_{n} ( {t}^{′} ) {\vert \vert}^{2} \qquad ( 2 )$$

where,
L_{align} may represent alignment loss,

$${f}_{align}^{m , n}$$

may represent a learned alignment function mapping one or more of the plurality of encoded input embedding values from modality m (e.g., the video data) to the closest corresponding input embedding values in modality n (e.g., the audio data), and t′ may represent an optimally aligned timestamp in modality n corresponding to time t′ in modality m.

Equation (2) may minimize temporal misalignment between the plurality of time-series data streams by learning the appropriate mapping of timestamps across different time-series data streams. Thus, even if some time-series data streams are bursty, sparse, or have missing values, the set of temporal alignment layers 202 may align temporally matched encoded input embedding values onto the unified temporal grid. Continuing the above-described example, the set of temporal alignment layers 202 may detect a sudden gesture at time 2.4s of the encoded video data. Further, the set of temporal alignment layers 202 may pull in the encoded heart rate data that are close to 2.4 s (even if they don't perfectly line up), giving them higher weight or interpolating toward them. Thus, the heart rate data may be contextually aligned to key moments in the video data, irrespective of different sampling frequencies.

The set of temporal alignment layers 202 may be conditioned on both the target time and the state/features of other time-series data streams at or around that time to align a corresponding time-series data stream onto the unified temporal grid. For example, weights for aligning heart rate data to a sample point may be modulated by a summary vector of video features at that sample point.

In some examples, the set of temporal alignment layers 202 may utilize a neural weighting function that combines time difference from the unified temporal grid, similarity of encoded input embedding values between the plurality of encoded input embedding values, and learnable parameters, to enable the above-described alignment.

In some embodiments, the set of temporal alignment layers 202 may correspond to a set of dynamic time warping (DTW) neural layers. The set of DTW neural layers may be configured to align, for each sample point of the plurality of sample points, the corresponding encoded one or more input embedding values of the corresponding plurality of encoded input embedding values for each encoded time-series data stream of the plurality of encoded time-series data streams 204. In some examples, the set of DTW neural layers may implement DTW functions for the alignment of the plurality of encoded time-series data streams 204.

In some embodiments, the set of temporal alignment layers 202 may correspond to a set of interpolation kernel layers. The set of interpolation kernel layers may be configured to align, for each sample point of the plurality of sample points, the corresponding one or more encoded input embedding values of the corresponding plurality of encoded input embedding values for each encoded time-series data stream of the plurality of encoded time-series data streams 204. In some examples, the set of interpolation kernel layers may implement differential interpolation functions for the alignment of the plurality of encoded time-series data streams 204.

In some embodiments, the set of temporal alignment layers 202 may correspond to a set of self-attention layers. The set of self-attention layers may be configured to align, for each sample point of the plurality of sample points, the corresponding one or more encoded input embedding values of the corresponding plurality of encoded input embedding values for each encoded time-series data stream of the plurality of encoded time-series data streams 204. In some examples, the set of self-attention layers may implement self-attention functions for the alignment of the plurality of encoded time-series data streams 204.

In some embodiments, the set of temporal alignment layers 202 may correspond to a set of cross-attention layers. The set of cross-attention layers may be configured to align, for each sample point of the plurality of sample points, the corresponding one or more encoded input embedding values of the corresponding plurality of encoded input embedding values for each encoded time-series data stream of the plurality of encoded time-series data streams 204. In some examples, the set of cross-attention layers may implement cross-attention functions for the alignment of the plurality of encoded time-series data streams 204.

In various embodiments, the set of temporal alignment layers 202 may determine, for each sample point of the plurality of sample points, a plurality of attention weights over the plurality of encoded input embedding values for each encoded time-series data stream. Further, the set of temporal alignment layers 202 may align, for each sample point, the one or more encoded input embedding values based on the corresponding one or more attention weights of the plurality of attention weights. In some examples, the set of temporal alignment layers 202 may perform the above-described alignment based on equation (3):

$${\tilde{E}}_{m} ( t ) = {\sum }_{i} {α}_{i , t}^{( m )} {E}_{m} ( {t}_{i} ) \qquad ( 3 )$$

where,
\tilde{E}ₘ(t) may represent an encoded input embedding value aligned at a sample point tᵢ of the plurality of sample points,
Eₘ(tᵢ) may represent an encoded input embedding value at timestamp tᵢ in the plurality of encoded input embedding values, and

$${α}_{i , t}^{( m )}$$

may represent one or more attention weights of the plurality of attention weights for aligning (tᵢ) to (tₜ).

To summarize, the set of temporal alignment layers 202 may correspond to learnable layers that enable adaptive alignment of the plurality of encoded time-series data streams 204 onto the unified temporal grid. Thus, the plurality of aligned time-series data streams 206 is contextually synchronized with respect to each other.

The ML model 114 may further include a plurality of attention layers 208 associated with the plurality of attention windows. The plurality of attention layers 208 may be coupled to the set of temporal alignment layers 202. Each attention layer of the plurality of attention layers 208 may be configured to receive the plurality of aligned time-series data streams 206. Further, each attention layer of the plurality of attention layers 208 may be configured to perform the cross-attention on the plurality of aligned time-series data streams 206 based on a corresponding attention window of the plurality of attention windows, and generate the corresponding cross-attention output based on the performed cross-attention. In some examples, each attention layer of the plurality of attention layers 208 may be configured to perform the cross-attention in parallel.

For the sake of brevity, the plurality of attention layers 208 is shown to include a first attention layer 208a, a second attention layer 208b, and a third attention layer 208c. Each attention window is associated with a corresponding attention window of the plurality of attention windows. For example, the first attention layer 208a may be associated with the first attention window, the second attention layer 208b may be associated with the second attention window, and the third attention layer 208c may be associated with the third attention window. As described earlier, the time duration associated with the first attention window is shorter than the time duration associated with the second attention window, and the time duration associated with the second attention window is shorter than the time duration associated with the third attention window. Thus, the first attention window may correspond to a short-term window, the second attention window may correspond to a mid-term window, and the third attention window may correspond to a long-term window.

To perform the cross-attention on the plurality of aligned time-series data streams 206, the first attention layer 208a may be configured to generate a plurality of queries, a plurality of keys, and a plurality of values for each aligned time-series data stream of the plurality of aligned time-series data streams 206. Further, the first attention layer 208a may be configured to determine, for each aligned time-series data stream of the plurality of aligned time-series data streams 206, a plurality of attention scores between a corresponding plurality of queries and a plurality of keys associated with each remaining aligned time-series data stream of the plurality of aligned time-series data streams 206.

The first attention layer 208a may be further configured to generate, for each aligned time-series data stream of the plurality of aligned time-series data streams 206, a plurality of output values based on a corresponding plurality of attention scores and a plurality of values associated with each remaining aligned time-series data stream of the plurality of aligned time-series data streams 206. Particularly, the first attention layer 208a may generate, for an aligned time-series data stream, a plurality of intermediate output values based on the corresponding plurality of attention scores and the plurality of values associated with a corresponding remaining aligned time-series data stream of the plurality of aligned time-series data streams 206. Thus, multiple plurality of intermediate output values may be generated for the corresponding aligned time-series data stream. The first attention layer 208a may utilize equation (4) for generating a corresponding plurality of intermediate output values:

$$Attention ( Q , K , V ) = Softmax ( \frac{{QK}^{T}}{\sqrt{{d}_{k}}} ) V \qquad ( 4 )$$

where,
Q may represent a plurality of queries associated with a target aligned time-series data streams, K and V may represent a plurality of keys and a plurality of values, respectively, associated with a different aligned time-series data streams, and
dₖ may represent a dimension associated with the plurality of keys.

Further, the first attention layer 208a may be configured to aggregate the multiple plurality of intermediate output values to generate the plurality of output values for the corresponding aligned time-series data stream. The plurality of output values for each remaining aligned time-series data stream may be determined in the above-described manner. The cross-attention output (hereinafter referred to as “the cross-attention output 210a”) may be generated based on the plurality of output values associated with each aligned time-series data stream of the plurality of aligned time-series data streams 206. The first attention layer 208a may aggregate (e.g., concatenate, sum, fusion function, or the like) the plurality of output values associated with the plurality of aligned time-series data streams 206 to generate the cross-attention output 210a for the first attention window. Thus, the first attention layer 208a may generate the cross-attention output 210a based on the duration (e.g., 0.5 seconds) associated with the first attention window.

In various embodiments, the cross-attention may be executed for each attention window of the plurality of attention windows in a pairwise or shared, multi-head setup.

The second attention layer 208b and the third attention layer 208c may be configured to generate the corresponding cross-attention outputs similar to the generation of the cross-attention output by the first attention layer 208a. The second attention layer 208b may generate the cross-attention output (hereinafter referred to as “the cross-attention output 210b”) based on the duration (e.g., 2 seconds) associated with the second attention window. Further, the third attention layer 208c may generate the cross-attention output (hereinafter referred to as “the cross-attention output 210c”) based on the duration (e.g., 3 seconds) associated with the third attention window. Thus, the cross-attention between the plurality of aligned time-series data streams 206 is executed at multiple temporal scales (e.g., the plurality of attention windows).

Continuing the above-described example, the cross-attention output 210a generated by the first attention layer 208a may capture rapid changes (e.g., breathing spike), the cross-attention output 210b generated by the second attention layer 208b may capture physiological drift (e.g., increase in heart rate), and the cross-attention output 210c generated by the third attention layer 208c may capture changes in the global health pattern. Thus, the execution of the cross-attention at the plurality of attention layers 208 enables focusing on fine granularity based on transient events (in short-term window), trends over intermediate periods (in the mid-term window), and broader context and slowly changing patterns (in the long-term window). Additionally, the cross-attention output at each window of the plurality of windows may correspond to a set of features representing interactions between the plurality of aligned time-series data streams 206 specific to the corresponding temporal context. Furthermore, the execution of the cross-attention at the plurality of attention layers 208 may avoid overfitting to noise in short windows and averaging out of meaningful short events in long windows.

The first attention layer 208a may be configured to output the corresponding cross-attention output 210a. The second attention layer 208b may be configured to output the corresponding cross-attention output 210b. Additionally, the third attention layer 208c may be configured to output the corresponding cross-attention output 210c.

The ML model 114 may further include a fusion layer 212 coupled to the plurality of attention layers 208. The fusion layer 212 may be configured to receive the cross-attention output generated by each attention layer of the plurality of attention layers 208. Thus, the fusion layer 212 may receive the cross-attention outputs 210a-210c. Further, the fusion layer 212 may be configured to hierarchically fuse the received cross-attention outputs 210a-210c to generate the plurality of fused embeddings (hereinafter referred to as “the plurality of fused embeddings 214”). In some examples, the hierarchical fusing of the received cross-attention outputs 210a-210c may correspond to an aggregation (e.g., averaging, weighted summation, max pooling, or hierarchical concatenation) of the received cross-attention outputs 210a-210c.

In some examples, the fusion layer 212 may utilize equation (5) for hierarchically fusing the received cross-attention outputs 210a-210c:

$${E}_{fused} = [ {E}_{short} ; {E}_{mid} ; {E}_{long} ] {W}_{fusion} \qquad ( 5 )$$

where,
E_{fused} may represent the plurality of fused embeddings 214,
Eₛₕₒᵣₜ may represent the cross-attention output 210a,
E_{mid} may represent the cross-attention output 210b,
E_{long} may represent the cross-attention output 210c, and
W_{fusion} may represent a learnable fusion weight matrix for hierarchically fusing the cross-attention outputs 210a-210c.

Continuing the above-described example, where the encoded audio data and the encoded video data correspond to 256-dimensional vectors, and the encoded heart rate data and the text data correspond to 128-dimensional vectors, the plurality of fused embeddings 214 may correspond to a 768-dimensional vector. Further, the fusion layer 212 may be configured to output the generated plurality of fused embeddings 214.

The ML model 114 may further include a set of prediction layers 216 coupled to the fusion layer 212. The set of prediction layers 216 may be configured to receive the plurality of fused embeddings 214. Further, the set of prediction layers 216 may be configured to generate the prediction output (hereinafter referred to as “the prediction output 218”) based on the received plurality of fused embeddings 214.

In some embodiments, the set of prediction layers 216 may utilize equation (6) to generate the prediction output 218:

$${Y}_{pred} = Softmax ( {W}_{task} \cdot {E}_{fused} + {b}_{task} ) \qquad ( 6 )$$

where,
Wₜₐₛₖ and bₜₐₛₖ may represent task-specific learned weights and biases, and
Y_{pred} may represent probability distribution over prediction classes.

In such embodiments, the prediction output 218 may correspond to a classification score. Continuing the above-described example, the task may correspond to the classification of patient state, the prediction classes may include normal, elevated, and critical, and the prediction output 218 may represent a probability score for each prediction class. In a non-limiting example, the prediction output 218 may represent 0.05 as the probability score for normal, 0.30 as the probability score for elevated, and 0.65 as the probability score for critical. The interpretation of this prediction may be that the patient has a 65% probability of a critical health event occurring at 2.4 seconds of the 3-second time duration.

In some embodiments, the set of prediction layers 216 may utilize equation (7) to generate the prediction output 218:

$${Y}_{pred} = {W}_{task} \cdot {E}_{fused} + {b}_{task} \qquad ( 7 )$$

where,
Wₜₐₛₖ and bₜₐₛₖ may represent task-specific learned weights and biases, and
Y_{pred} may represent probability distribution over prediction classes.

In such embodiments, the prediction output 218 may correspond to a regression value. In various embodiments, the ML model 114 may be trainable. In some examples, the processing circuitry 108 may be configured to train the ML model 114.

Although it is described that the plurality of attention windows includes three attention windows, the scope of the present disclosure is not limited to it. In various embodiments, the plurality of attention windows may include more than or less than three attention windows, without deviating from the scope of the present disclosure. In such embodiments, a number of attention layers in the plurality of attention layers 208 may be same as a number of attention windows in the plurality of attention windows.

Although it is described that the plurality of data streams is asynchronous, the scope of the present disclosure is not limited to it. In various embodiments, at least one time-series data stream of the plurality of time-series data streams may be asynchronous with respect to at least one remaining time-series data stream of the plurality of time-series data streams, without deviating from the scope of the present disclosure. In such embodiments, the ML model 114 may be configured to align the at least one time-series data stream to the unified temporal grid, without deviating from the scope of the present disclosure.

Although it is described that the sampling frequency of each time-series data stream of the plurality of time-series data streams is different from the sampling frequency of each remaining time-series data stream of the plurality of time-series data streams, the scope of the present disclosure is not limited to it. In various embodiments, the sampling frequency of at least one time-series data stream of the plurality of time-series data streams may be different from the sampling frequency of at least one remaining time-series data stream of the plurality of time-series data streams, without deviating from the scope of the present disclosure. In such embodiments, the ML model 114 may be configured to align the at least one time-series data stream to the unified temporal grid, without deviating from the scope of the present disclosure.

Although the example described in conjunction with FIGS. 1 and 2 correspond to the classification of the patient state, the scope of the present disclosure is not limited to it. In further embodiments, the system 102 described in the present disclosure may be utilized for detection of drowsiness of a driver in a smart vehicle, without deviating from the scope of the present disclosure. In such embodiments, the plurality of time-series data streams may include video data (captured at 25 fps) indicative of eyelid closure and head movement of the driver, brainwave data (captured at 256 Hz) indicative of alertness of the driver, pressure data (captured at 1 Hz) indicative of grip pressure changes on a steering wheel of the smart vehicle, and audio data (captured at 8 kHz) indicative of changes in speech tone of the driver. The video data may indicate an eyes open event at 0.00 seconds, a blink at 0.40 seconds, a slow blink at 1.20 seconds, a head nod at 2.50 seconds, and micro-sleep at 5 seconds. Further, the brainwave data may indicate high alert at 0.00 and 0.40 seconds, slight drop at 1.20 seconds, and low alert at 2.50 and 5 seconds. The pressure data may indicate firm grip at 0.00, 0.40, and 1.20 seconds, reduced grip at 2.50 seconds, and loose grip at 5 seconds. The audio data may indicate normal tone at 0.00 seconds, slight slur at 1.20 seconds, slurred speech at 2.50 seconds, and silence at 5 seconds.

Further, the ML model 114 may determine a sampling frequency (e.g., anchor) for an adaptive temporal grid based on the plurality of time-series data streams. Continuing the above example, the anchors for the adaptive temporal grid may be 0.0 seconds, 0.4 seconds, 1.2 seconds, 2.5 seconds, 3.0 seconds, and 5 seconds. An extra anchor at 3.0 seconds may be introduced to capture dip in the brainwave data between head nod and micro-sleep. The processing circuitry 108 may align the plurality of time-series data streams onto the adaptive temporal grid. The drop in the brainwave data at 3.0 seconds may be pulled forward based on the changes in the video data and the audio data. Additionally, grip pressure changes in the pressure data at 2.5 seconds may shift slightly towards the head nod in the video data for better temporal matching. The processing circuitry 108 may further determine a short-term attention window (e.g., #1 anchor), a mid-term attention window (e.g., +3 anchors), and a long-term attention window (e.g., entire 5 seconds). The short-term attention window may capture immediate reactions such as blink to speech change, the mid-term attention window may capture a sequence from blink to head nod to low alert, and the long-term attention window may capture gradual fatigue build-up. The processing circuitry 108 may further execute cross attention on the aligned time-series data streams across the short-term, mid-term, and long-term windows. Further, the ML model 114 may detect drowsy state with high confidence score before micro-sleep at 5 seconds based on the execution of the cross-attention and fusion of the cross-attention outputs.

In additional embodiments, the system 102 described in the present disclosure may be utilized for fault detection in smart factories, without deviating from the scope of the present disclosure. In such embodiments, the plurality of time-series data streams may include vibration data captured by vibration sensors, temperature data captured by thermal cameras, audio data captured by acoustic sensors, and operational logs that are asynchronous. The processing circuitry 108 may align asynchronous sensor readings with machine events (e.g., vibration patterns in the vibration data may be aligned based on a sudden temperature spike in the temperature data). Additionally, the processing circuitry 108 may execute cross attention across the plurality of attention windows, thereby enabling focus on critical anomaly periods. As a result, the ML model 114 may achieve early fault detection in the smart factory and thus reduce downtime.

In numerous embodiments, the system 102 described in the present disclosure may be utilized for sports performance analytics for a match, without deviating from the scope of the present disclosure. In such embodiments, the plurality of time-series data streams may include player position data, video data, audio data, and heart rate data, captured during the match. The processing circuitry 108 may align the plurality of time-series data such that heart rate spikes and positional bursts are aligned based on relevant video frames in the video data. Further, the processing circuitry 108 may execute cross-attention on the aligned plurality of time-series data across short-term and long-term attention windows. The short-term attention window captures playmaking moments, and the long-term attention window captures stamina decline over the entire duration of the match. Further, the processing circuitry 108 may obtain detailed performance analytics based on the above-described operations. The detailed performance analytics may be utilized for training and injury prevention.

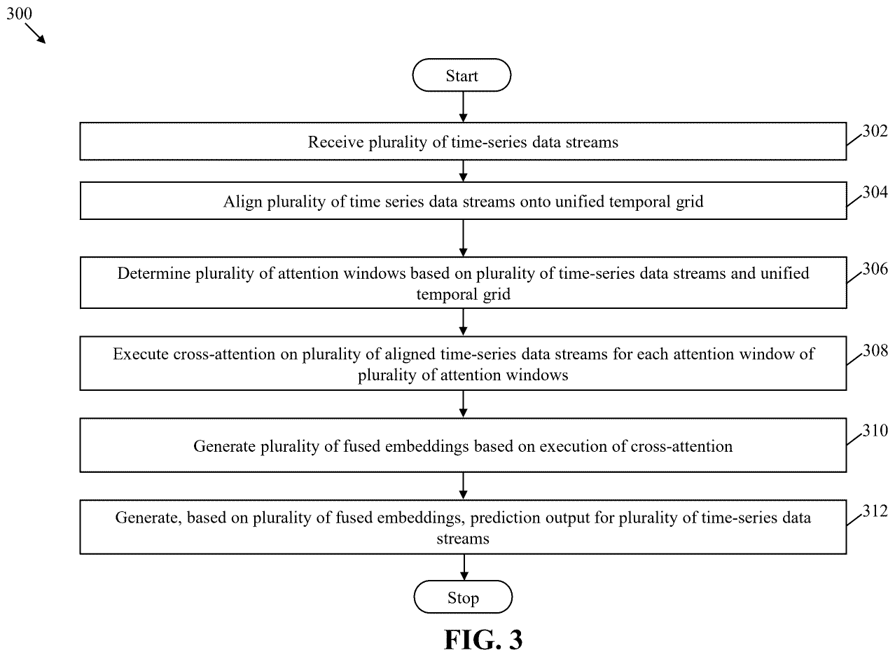

FIG. 3 represents a flowchart 300 that illustrates a method for prediction based on asynchronous and heterogeneous time-series data streams, consistent with disclosed embodiments of the present disclosure.

At 302, the processing circuitry 108 may receive the plurality of time-series data streams. The plurality of time-series data streams may be received from the plurality of sensors 102. At least one time-series data stream of the plurality of time-series data streams may be asynchronous with respect to at least one remaining time-series data stream of the plurality of time-series data streams. Further, a sampling frequency of at least one time-series data stream of the plurality of time-series data streams may be different from a sampling frequency of at least one remaining time-series data stream of the plurality of time-series data streams.

At 304, the processing circuitry 108 (e.g., the set of temporal alignment layers 202) may align the plurality of time-series data streams onto the unified temporal grid. The plurality of aligned time-series data streams 206 is synchronous, and the sampling frequency of each aligned time-series data stream is same as the sampling frequency of each remaining aligned time-series data stream of the plurality of aligned time-series data streams 206. In some examples, the plurality of encoding models 112 may generate and output the plurality of encoded time-series data streams 204. Thus, the plurality of encoded time-series data streams 204 may be aligned onto the unified temporal grid.

At 306, the processing circuitry 108 may determine the plurality of attention windows based on the plurality of time-series data streams and the unified temporal grid. The time duration associated with each attention window of the plurality of attention windows may be different from the time duration associated with each remaining attention window of the plurality of attention windows.

At 308, the processing circuitry 108 (e.g., the plurality of attention layers 208) may execute the cross-attention on the plurality of aligned time-series data streams 206 for each attention window of the plurality of attention windows. A cross-attention output may be generated based on the execution of the cross-attention for a corresponding attention window of the plurality of attention windows.

At 310, the processing circuitry 108 (e.g., the fusion layer 212) may generate the plurality of fused embeddings 214 based on the execution of the cross-attention. The plurality of fused embeddings 214 may be generated based on the cross-attention outputs associated with the plurality of attention windows.

At 312, the processing circuitry 108 (e.g., the set of prediction layers 216) may generate, based on the plurality of fused embeddings 214, the prediction output 218 for the plurality of time-series data streams. The prediction output 218 may correspond to one of a classification score, a regression value, an anomaly detection score, or a control command. Herein, it may be noted that the alignment (at 304) and the cross-attention operations (at 308) are performed using the machine learning model 114 trained to optimize prediction accuracy across asynchronous and heterogeneous modalities.

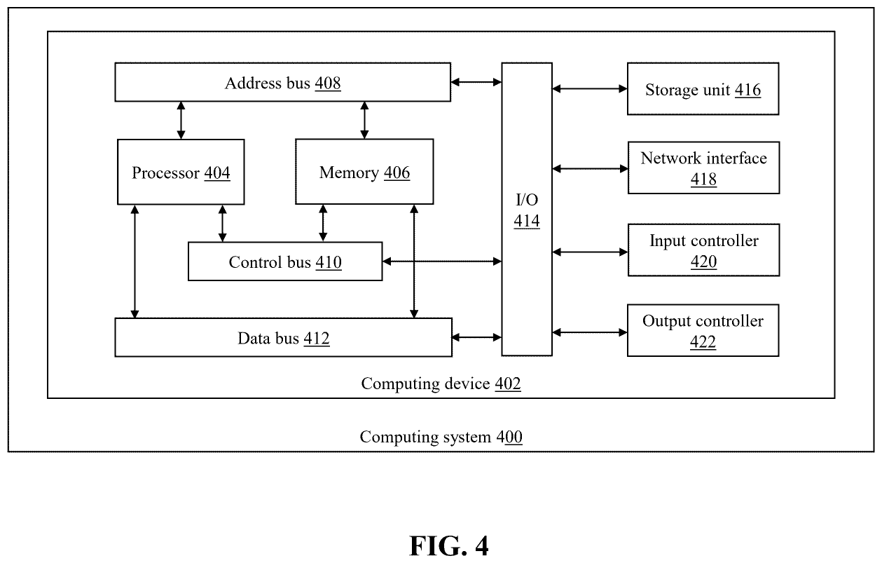

FIG. 4 shows an example computing system 400 for carrying out the methods of the present disclosure, consistent with disclosed embodiments of the present disclosure. Specifically, FIG. 4 shows a block diagram of an embodiment of the computing system 400 according to example embodiments of the present disclosure.

The computing system 400 may be configured to perform any of the operations disclosed herein. The computing system 400 may be implemented as a conventional computer system, an embedded controller, a laptop, a server, a mobile device, a smartphone, a customized machine, any other hardware platform, or any combination or multiplicity thereof. In one embodiment, the computing system 400 is a distributed system configured to function using multiple computing machines interconnected via a data network or bus system.

The computing system 400 includes computing devices (such as a computing device 402). The computing device 402 includes one or more processors (such as a processor 404) and a memory 406. The processor 404 may be any general-purpose processor(s) configured to execute a set of instructions. For example, the processor 404 may be a processor core, a multiprocessor, a reconfigurable processor, a microcontroller, a digital signal processor (DSP), an application-specific integrated circuit (ASIC), a graphics processing unit (GPU), a neural processing unit (NPU), an accelerated processing unit (APU), a brain processing unit (BPU), a data processing unit (DPU), a holographic processing unit (HPU), an intelligent processing unit (IPU), a microprocessor/microcontroller unit (MPU/MCU), a radio processing unit (RPU), a tensor processing unit (TPU), a vector processing unit (VPU), a wearable processing unit (WPU), a field programmable gate array (FPGA), a programmable logic device (PLD), a controller, a state machine, gated logic, discrete hardware component, any other processing unit, or any combination or multiplicity thereof. In one embodiment, the processor 404 may be multiple processing units, a single processing core, multiple processing cores, special purpose processing cores, co-processors, or any combination thereof. The processor 404 may be communicatively coupled to the memory 406 via an address bus 408, a control bus 410, and a data bus 412.

The memory 406 may include non-volatile memories such as a read-only memory (ROM), a programable read-only memory (PROM), an erasable programmable read-only memory (EPROM), a flash memory, or any other device capable of storing program instructions or data with or without applied power. The memory 406 may also include volatile memories, such as a random-access-memory (RAM), a static random-access-memory (SRAM), a dynamic random-access-memory (DRAM), and a synchronous dynamic random-access-memory (SDRAM). The memory 406 may include single or multiple memory modules. While the memory 406 is depicted as part of the computing device 402, a person skilled in the art will recognize that the memory 406 may be separate from the computing device 402.

The memory 406 may store information that may be accessed by the processor 404. For instance, the memory 406 (e.g., one or more non-transitory computer-readable storage mediums, memory devices) may include computer-readable instructions (not shown) that may be executed by the processor 404. The computer-readable instructions may be software written in any suitable programming language or may be implemented in hardware. Additionally, or alternatively, the computer-readable instructions may be executed in logically and/or virtually separate threads on the processor 404. For example, the memory 406 may store instructions (not shown) that when executed by the processor 404 cause the processor 404 to perform operations such as any of the operations and functions for which the computing system 400 is configured, as described herein. Additionally, or alternatively, the memory 406 may store data (not shown) that may be obtained, received, accessed, written, manipulated, created, and/or stored. The data may include, for instance, the data and/or information described herein in relation to FIGS. 1-3. In some implementations, the computing device 402 may obtain from and/or store data in one or more memory device(s) that are remote from the computing system 400.

The computing device 402 may further include an input/output (I/O) interface 414 communicatively coupled to the address bus 408, the control bus 410, and the data bus 412. The data bus 412 may include a plurality of tunnels that may support communication in the environment 100. The I/O interface 414 is configured to couple to one or more external devices (e.g., to receive and send data from/to one or more external devices). Such external devices, along with the various internal devices, may also be known as peripheral devices. The I/O interface 414 may include both electrical and physical connections for operably coupling the various peripheral devices to the computing device 402. The I/O interface 414 may be configured to communicate data, addresses, and control signals between the peripheral devices and the computing device 402. The I/O interface 414 may be configured to implement any standard interface, such as a small computer system interface (SCSI), a serial-attached SCSI (SAS), a fiber channel, a peripheral component interconnect (PCI), a PCI express (PCIe), a serial bus, a parallel bus, an advanced technology attachment (ATA), a serial ATA (SATA), a universal serial bus (USB), Thunderbolt, FireWire, various video buses, and the like. The I/O interface 414 is configured to implement only one interface or bus technology. Alternatively, the I/O interface 414 is configured to implement multiple interfaces or bus technologies. The I/O interface 414 may include one or more buffers for buffering transmissions between one or more external devices, internal devices, the computing device 402, or the processor 404. The I/O interface 414 may couple the computing device 402 to various input devices, including touch screens, scanners, biometric readers, electronic digitizers, receivers, touchpads, cameras, keyboards, any other pointing devices, or any combinations thereof. The I/O interface 414 may couple the computing device 402 to various output devices, including printers, projectors, tactile feedback devices, automation control, robotic components, actuators, transmitters, signal emitters, lights, and so forth.

The computing system 400 may further include a storage unit 416, a network interface 418, an input controller 420, and an output controller 422. The storage unit 416, the network interface 418, the input controller 420, and the output controller 422 are communicatively coupled to the central control unit (e.g., the memory 406, the address bus 408, the control bus 410, and the data bus 412) via the I/O interface 414. The network interface 418 communicatively couples the computing system 400 to one or more networks such as wide area networks (WAN), local area networks (LAN), intranets, the Internet, wireless access networks, wired networks, mobile networks, telephone networks, optical networks, or combinations thereof. The network interface 418 may facilitate communication with packet-switched networks or circuit-switched networks which use any topology and may use any communication protocol. Communication links within the network may involve various digital or analog communication media such as fiber optic cables, free-space optics, waveguides, electrical conductors, wireless links, antennas, radio-frequency communications, and so forth.

The storage unit 416 is a computer-readable medium, preferably a non-transitory computer-readable medium, comprising one or more programs, the one or more programs comprising instructions which when executed by the processor 404 cause the computing system 400 to perform the method steps of the present disclosure. Alternatively, the storage unit 416 is a transitory computer-readable medium. The storage unit 416 may include a hard disk, a floppy disk, a compact disc read-only memory (CD-ROM), a digital versatile disc (DVD), a Blu-ray disc, a magnetic tape, a flash memory, another non-volatile memory device, a solid-state drive (SSD), any magnetic storage device, any optical storage device, any electrical storage device, any semiconductor storage device, any physical-based storage device, any other data storage device, or any combination or multiplicity thereof. In one embodiment, the storage unit 416 stores one or more operating systems, application programs, program modules, data, or any other information. The storage unit 416 is part of the computing device 402. Alternatively, the storage unit 416 is part of one or more other computing machines that are in communication with the computing device 402, such as servers, database servers, cloud storage, network attached storage, and so forth.

The input controller 420 may include suitable logic, circuitry, interfaces, and/or code, executable by the circuitry, that may be configured to control one or more input devices that may be configured to receive the plurality of time-series data streams. The output controller 422 may include suitable logic, circuitry, interfaces, and/or code, executable by the circuitry, that may be configured to control one or more output devices that may be configured to output the prediction output.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however, some of the operations may be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the present disclosure provide, among other features, systems and methods for prediction based on asynchronous and heterogeneous time-series data streams. While various embodiments of the disclosed systems and methods have been described above, they have been presented for purposes of example only, and not limitations. It is not exhaustive and does not limit the present disclosure to the precise form disclosed. Modifications and variations are possible considering the above teachings or may be acquired from practicing the present disclosure, without departing from the breadth or scope.

What is claimed is:

1. A system, comprising:
processing circuitry configured to:
receive a plurality of time-series data streams associated with a plurality of heterogeneous data types, respectively, wherein at least one time-series data stream of the plurality of time-series data streams is asynchronous with respect to at least one remaining time-series data stream of the plurality of time-series data streams, and wherein a sampling frequency of at least one time-series data stream of the plurality of time-series data streams is different from a sampling frequency of at least one remaining time-series data stream of the plurality of time-series data streams;
align the plurality of time-series data streams onto a unified temporal grid, wherein the plurality of aligned time-series data streams is synchronous and a sampling frequency of each aligned time-series data stream is same as a sampling frequency of each remaining aligned time-series data stream of the plurality of aligned time-series data streams;
execute cross-attention on the plurality of aligned time-series data streams for each attention window of a plurality of attention windows, wherein a time duration associated with each attention window of the plurality of attention windows is different from a time duration associated with each remaining attention window of the plurality of attention windows;
generate a plurality of fused embeddings based on the execution of the cross-attention; and
generate, based on the plurality of fused embeddings, a prediction output for the received plurality of time-series data streams.

2. The system of claim 1, further comprising a storage element coupled to the processing circuitry and configured to store a machine learning (ML) model,
wherein the processing circuitry is configured to execute the ML model based on the plurality of time-series data streams to align the plurality of time-series data streams onto the unified temporal grid, and
wherein the ML model is configured to:
receive the plurality of time-series data streams as input, where each time-series data stream includes a plurality of input embedding values;
determine a sampling frequency for the unified temporal grid based on the plurality of time-series data streams, wherein the unified temporal grid represents a plurality of sample points based on the determined sampling frequency;
align, for each sample point of the plurality of sample points, corresponding one or more input embedding values of a corresponding plurality of input embedding values for the at least one time-series data stream of the plurality of time-series data streams; and
output the plurality of aligned time-series data streams based on the alignment for each sample point of the plurality of sample points.

3. The system of claim 2, wherein the alignment for each sample point of the plurality of sample points for a corresponding time-series data stream of the plurality of time-series data streams is based on the corresponding time-series data stream.

4. The system of claim 2, wherein the alignment for each sample point of the plurality of sample points for a corresponding time-series data stream of the plurality of time-series data streams is based on the corresponding time-series data stream and one or more remaining time-series data streams of the plurality of time-series data streams.

5. The system of claim 2, wherein the ML model includes a set of interpolation kernel layers configured to align, for each sample point of the plurality of sample points, the corresponding one or more input embedding values of the corresponding plurality of input embedding values for the at least one time-series data stream of the plurality of time-series data streams.

6. The system of claim 2, wherein the ML model includes a set of dynamic time warping (DTW) neural layers configured to align, for each sample point of the plurality of sample points, the corresponding one or more input embedding values of the corresponding plurality of input embedding values for the at least one time-series data stream of the plurality of time-series data streams.

7. The system of claim 2, wherein the ML model includes a set of self-attention layers configured to align, for each sample point of the plurality of sample points, the corresponding one or more input embedding values of the corresponding plurality of input embedding values for the at least one time-series data stream of the plurality of time-series data streams.

8. The system of claim 2, wherein the ML model includes a set of cross-attention layers configured to align, for each sample point of the plurality of sample points, the corresponding one or more input embedding values of the corresponding plurality of input embedding values for the at least one time-series data stream of the plurality of time-series data streams.

9. The system of claim 1, further comprising a storage element coupled to the processing circuitry and configured to store a plurality of encoding models, wherein the processing circuitry is configured to:
provide the plurality of time-series data streams as input to the plurality of encoding models, respectively; and
obtain a plurality of encoded time-series data streams as output of the plurality of encoding models, respectively, wherein the plurality of encoded time-series data streams is aligned onto the unified temporal grid, and wherein each encoding model of the plurality of encoding models is configured to:
receive a corresponding time-series data stream of the plurality of time-series data streams;
generate an encoded time-series data stream based on the received time-series data stream, wherein the encoded time-series data stream is suitable for ML processing; and
output the encoded time-series data stream.

10. The system of claim 1, wherein the processing circuitry is further configured to determine the plurality of attention windows based on the plurality of time-series data streams and the unified temporal grid.

11. The system of claim 10, further comprising a storage element coupled to the processing circuitry and configured to store an ML model,
wherein the processing circuitry is configured to execute the cross-attention based on the ML model,
wherein the ML model includes a plurality of attention layers associated with the plurality of attention windows, respectively, and
wherein each attention layer of the plurality of attention layers is configured to:
receive the plurality of aligned time-series data streams;
perform the cross-attention on the plurality of aligned time-series data streams based on a corresponding attention window of the plurality of attention windows; and
generate a cross-attention output based on the performed cross-attention.

12. The system of claim 11, wherein to perform the cross-attention on the plurality of aligned time-series data streams, each attention layer of the plurality of attention layers is configured to:
generate a plurality of queries, a plurality of keys, and a plurality of values for each aligned time-series data stream of the plurality of aligned time-series data streams;
determine, for each aligned time-series data stream of the plurality of aligned time-series data streams, a plurality of attention scores between a corresponding plurality of queries and a plurality of keys associated with each remaining aligned time-series data stream of the plurality of aligned time-series data streams; and
generate, for each aligned time-series data stream of the plurality of aligned time-series data streams, a plurality of output values based on a corresponding plurality of attention scores and a plurality of values associated with each remaining aligned time-series data stream of the plurality of aligned time-series data streams, wherein the cross-attention output is generated based on the plurality of output values associated with each aligned time-series data stream of the plurality of aligned time-series data streams.

13. The system of claim 11, wherein each attention layer of the plurality of attention layers is configured to perform the cross-attention in parallel.

14. The system of claim 11, wherein the processing circuitry is configured to generate the plurality of fused embeddings further based on the ML model, wherein the ML model further includes a fusion layer, and wherein the fusion layer is configured to:
receive the cross-attention output generated by each attention layer of the plurality of attention layers; and
hierarchically fuse the received cross-attention outputs to generate the plurality of fused embeddings.

15. The system of claim 11, wherein the plurality of attention windows includes a first attention window, a second attention window, and a third attention window, and wherein a time duration associated with the first attention window is shorter than a time duration associated with the second attention window, and the time duration associated with the second attention window is shorter than a time duration associated with the third attention window.

16. The system of claim 1, further comprising a storage element coupled to the processing circuitry and configured to store an ML model,
wherein the processing circuitry is configured to generate the prediction output further based on the ML model,
wherein the ML model includes a set of prediction layers, and
wherein the set of prediction layers is configured to:
receive the plurality of fused embeddings; and
generate the prediction output based on the received plurality of fused embeddings.

17. A method, comprising:
receiving a plurality of time-series data streams associated with a plurality of heterogeneous data types, respectively, wherein at least one time-series data stream of the plurality of time-series data streams is asynchronous with respect to at least one remaining time-series data stream of the plurality of time-series data streams, and wherein a sampling frequency of at least one time-series data stream is different from a sampling frequency of at least one remaining time-series data stream of the plurality of time-series data streams;
aligning the plurality of time-series data streams onto a unified temporal grid, wherein the plurality of aligned time-series data streams is synchronous and a sampling frequency of each aligned time-series data stream is same as a sampling frequency of each remaining aligned time-series data stream of the plurality of aligned time-series data streams;
executing, cross-attention on the plurality of aligned time-series data streams for each attention window of a plurality of attention windows, wherein a time duration associated with each attention window of the plurality of attention windows is different from a time duration associated with each remaining attention window of the plurality of attention windows;
generating a plurality of fused embeddings based on the execution of the cross-attention; and
generating, based on the plurality of fused embeddings, a prediction output for the plurality of time-series data streams.

18. A method of claim 17, wherein aligning the plurality of time-series data streams onto the unified temporal grid comprises:
determining a sampling frequency for the unified temporal grid based on the plurality of time-series data streams, wherein the unified temporal grid represents a plurality of sample points based on the determined sampling frequency, and wherein each time-series data stream includes a plurality of input embedding values; and
aligning, for each sample point of the plurality of sample points, corresponding one or more input embedding values of a corresponding plurality of input embedding values for the at least one time-series data stream of the plurality of time-series data streams.

19. The method of claim 18, wherein the alignment for each sample point of the plurality of sample points for a corresponding time-series data stream of the plurality of time-series data streams is based on the corresponding time-series data stream and one or more remaining time-series data streams of the plurality of time-series data streams.

20. A non-transitory computer-readable medium comprising instructions that, when executed by processing circuitry of a computing system, cause the computing system to perform a method, the method comprising:
receiving a plurality of time-series data streams associated with a plurality of heterogeneous data types, respectively, wherein at least one time-series data stream of the plurality of time-series data streams is asynchronous with respect to at least one remaining time-series data stream of the plurality of time-series data streams, and wherein a sampling frequency of at least one time-series data stream is different from a sampling frequency of at least one remaining time-series data stream of the plurality of time-series data streams;
aligning the plurality of time-series data streams onto a unified temporal grid, wherein the plurality of aligned time-series data streams is synchronous and a sampling frequency of each aligned time-series data stream is same as a sampling frequency of each remaining aligned time-series data stream of the plurality of aligned time-series data streams;
executing, cross-attention on the plurality of aligned time-series data streams for each attention window of a plurality of attention windows, wherein a time duration associated with each attention window of the plurality of attention windows is different from a time duration associated with each remaining attention window of the plurality of attention windows;
generating a plurality of fused embeddings based on the execution of the cross-attention; and
generating, based on the plurality of fused embeddings, a prediction output for the plurality of time-series data streams.
